(19) United States
(12) Patent Application Publication
(10) Pub. No.: US 2019/0388941 A1
(43) Pub. Date: Dec. 26, 2019

(54) LOOP TOWEL

(71) Applicant: Rebecca McKenzie, Littleton, CO (US)

(72) Inventor: Rebecca McKenzie, Littleton, CO (US)

(21) Appl. No.: 16/016,607

(22) Filed: Jun. 24, 2018

(51) Int. Cl. B08B 1/00; A41F 9/00; A41D 23/00; A42B 1/04; A42B 1/00; A47L 19/00; A47K 10/02

(52) U.S. Cl. CPC B08B 1/006; A41F 9/002; A41D 23/00; A41D 2300/324; A42B 1/006; A47L 19/00; A47K 10/02; A42B 1/041

(57) ABSTRACT

A towel with a loop formed from the towel material to allow for a user to place a finger or a hand within the loop and manipulate the towel material with ease allowing the user to manage a large amount of material without the towel falling off of the user providing a more compact towel to maneuver. The loop is also hung from the user's person or a hook or a towel bar or a belt. The loop formed on a towel easily and quickly wraps and hangs around a towel bar.

### FEDERALLY SPONSERED RESEARCH

Not Applicable

### BACKGROUND OF THE INVENTION-FIELD OF INVENTION

This invention relates to towels in particular which a user may want ergonomics formed into the towels formation for ease of use, and so the user does not have to hold onto the entire towel to use portions of it, and as well as ease of transport. The entire towel may be waded into the user's hand, or a small portion sectioned out for use. The loop also provides leverage to the user while using the towel to perform the intended task. Additional embodiments may also be formed for dishwashing, hygiene, and for fashion purposes.

### SUMMARY

The Loop towel is a towel with a loop created, formed into, onto, or applied within and onto and to, to provide a material with a loop whereby the loop is a functional device for managing and manipulating and transporting and securing the material.

The loop formed to carry and re loop, and manage the material of the device.

The purpose of the loop is for allowing to the user, grasping and inserting fingers, hand wrist, and manipulating the material, dragging pinching, grasping, wrapping, transporting, also allowing for a user's person managing the looped material for use or covering a hand or a tool, or for manipulation.

Additionally a user may use the looped device in forming a belt, scarf or head covering from the looped material.

The loop also providing for the user to insert an item or a hand or fingers into the loop from either opening into the loop and grasping the outer area, while grabbing the inner area, to wipe, clean, wash, dry,scrub, polish, to complete any cleaning task easily and the most efficiency.

The loop also allowing for the users looping the material thru itself to form a scarf or belt or an arm drape. The user may also use the looped material as an adjustable arm brace by wrapping a lengthy amount of material around a user's person, to support the user's arm when carrying something heavy.

### Loop Towel Specifications

The Loop Towel/Material is a towel with a loop formed to a towel. The loop of the towel is looped over a towel bar or carried on a user's wrist area. The loop can be hung on or from a user or item, or the loop may be looped over an item or a user. The user may insert the hand of the user, and leverage the fingers to manipulate the other portions of the towel. The loop can also be applied to a material to create a scarf, for a fashion or functional neck and head covering.

The Loop Towel is a towel formed when two areas are adjoined to form a shallow loop from the material used, forming a towel with a loop. The open material is easily managed and doubled, and has a loop to carry the material.

The basic towel may be of any size, formed from a rectangle, square, or an odd shape of material. The purpose of the loop applied to the material, is to form a loop that a user may grasp, and also to hang the loop and towel from a user's arm hand or wrist, so that the user's may carry the towel as well as wrap the towel around the user's hand while the loop is hanging from the user's wrist. The hand may grasp a corner of the towel when the loop is around the user's wrist area. The towel loop keeps the user from having to hold all of the towel in the hand while tasking in wiping drying exfoliating polishing, etc. The fingers of a user can spread within the loop being of a size that would accommodate the user's hand appropriately and gives tension and leverage to manipulate the towel while holding the towel with the loop loosely attached to the user's hand, while using the towel. The loop provides a means to secure the towel to a variety of items during the towel's use as well as transporting the towel while resting on an item. The loop towel is used several different ways.

The loop may be placed anywhere on the device, or material at the adjacent corner of a towel with corners, or on the curve of a round towel as long as the loop enables for a finger to hook onto the loop, formed from and of the towel.

The looped towel may be knitted and formed into a towel with a loop.

The preferred loop towel is a square or rectangle adjoined at adjacent corners areas. An elongated material is formed from a square material, turned into a rectangle.

The loop is made by fastening an area to another area. Permanently fastened is preferred, but a hook and loop or snap fastener works as well. In a scarf or situations needing certain hanging requirements, a snap may be preferred for removal without unlooping the material from thru the loop first.

The length of the fastener may be about ⅛ to 4 inches, or more depending on the size of the towel and the intended use. A fastening may be applied to the top loop, or the side of the loop material, or both, or a centered fastener at the basic corner area. For extra strength a fastening such as a snap may be applied twice at opposing corner, or just double on one side.

An open area is available to the user for manipulating. The loop towel has use of both sides, and both ends, depending on how the towel is being manipulated.

The material may be of one or more materials. A single material may be used two different materials or two of the same materials may be adjoined. The towel loop towel may have different materials on each side, or different colors or a delineation pattern on each side. A patch of a same or similar or different material may be added to the surface of the towel material on one or both sides.

The loop towel may be made from a variety of materials to wash, clean, scrub, dry, and general cleaning, absorbing, hygiene. The loop towel made as a scarf may be of any desired material for fashion or for warmth in a scarf or head covering.

The loop can be adaptable in size as needed for the towels use. A towel or scarf may have different requirements in the manufacture of the use of the material.

The loop helps to manipulate, control and use the towel whether a user's fingers are within the loop, or the user has the loop hanging onto the user's wrist or forearm. When the fingers are spread within the loop of the loop towel, leverage to manipulate the towel is present. A face towel with exfoliation material or patch is used easily with this technique. Washing dishes is easier with a doubled material and a loop to manipulate around dishes and holding onto the looped towel while washing at the same time. This embodiment is also useful bathing so the user can grasp the loop of the looped towel without dropping the looped towel washcloth sized looped towel.

On a small infant size wash cloth, the user can easily hold the towel, use the towel, and manipulate the towel with ease. The user can insert one or more fingers into the loop, and manage the towel easily without completely needing to hold onto the entire towel material to use the towel. On a large towel or a long towel, the loop secures the towel to the user's wrist so that the towel does not drop down and drag. The user may keep the material of the towel wrapped around the users hand, or as well the user may grasp a corner of the towel to form a draped loop.

The user inserts their hand and grasps the towel.

The user inserts a finger or more into the towel loop to drag and carry the entire towel.

The user inserts several fingers upward through the towel loop to leverage the loop around the user's fingers to manipulate the towel.

The user can turn the towel inside out, and decipher one end of the towel from the other, as one end has the loop and a fastening means and the other end is open.

The towel allows a user to easily wipe and hold the towel at the same time, this is very useful when wiping a car, a pet, dishes, face washing, etc.

The user doesn't have to hold onto or control all of the towel's material since the loop let's a portion of the towel rest on the user.

The loop towel could have elastic applied to the loop if desired, with or without a fastener if the elastic is included in the loop creation during the knitting process if formed from knitting. The elastic may be added to the loop opening at any time in the process of making the loop.

The loop could be darted or made to be substantially smaller in comparison to opposing towel end. This is desirable with an automotive drying towel which may be formed from a towel material 2 feet wide by 3 feet long. This darting would also be useful in a scarf formed at such sizes, as well as a portion of the loop elasticized into the loop for a scarf The scarf may also be formed into a belt when applied to a user's waist and the end of the material is wrapped onto the area looped around a user's waist, becoming the belted area. A head wrap could also be created wrapping the material looped, then around a user's head.

The loop towel also wraps around a towel bar or oven handle, while leaving a large area for a person to wipe their hands on. When the loop towel is looped around a towel bar or the like, the towel does not fall off and is longer than the usual half folded towel on a towel bar or oven handle. In this use, a snap or hook n loop fastener may be a desired choice for quick removal. The loop towel naturally has a large loop to use as a hanging loop as is onto a bracket or hook.

The loop also lets the towel hang off a mop head while the handle is inserted through the loop. A snap as a fastener is also a good choice for this towel style and use. Many tools can be covered, the looped towel is a tool covering to protect the tool, and provide more surface area to an existed area.

The loop towel may be looped around a belt, with an open looped, or looped through its self. This transports and makes readily available for use to the user.

The loop towel may be looped onto an apron or bib apron, or a ribbon strung through the loop and tied to another item, or a person or a looped loop may be hung on a ribbon.

### DRAWING DESCRIPTIONS

FIG. 1A shows the basic form of the loop towel, and the small area fastened to create the loop onto a sheet of material.

FIG. 2A shows a rectangular or square shape of material with two corners connected and fastened to form a loop at one end of a towel material.

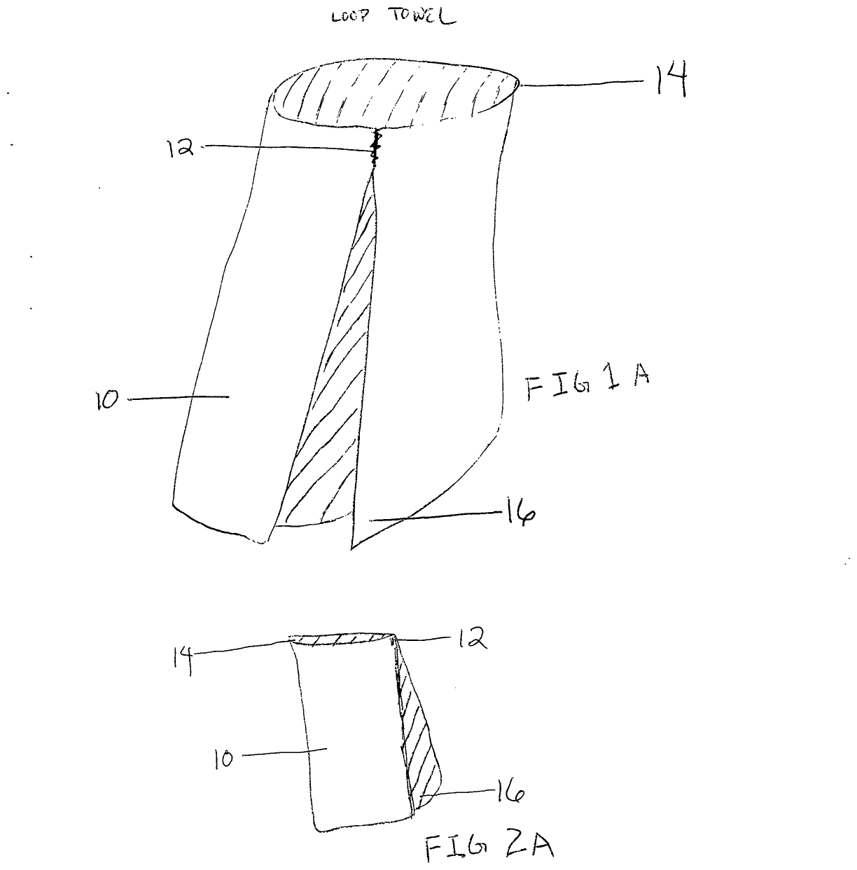

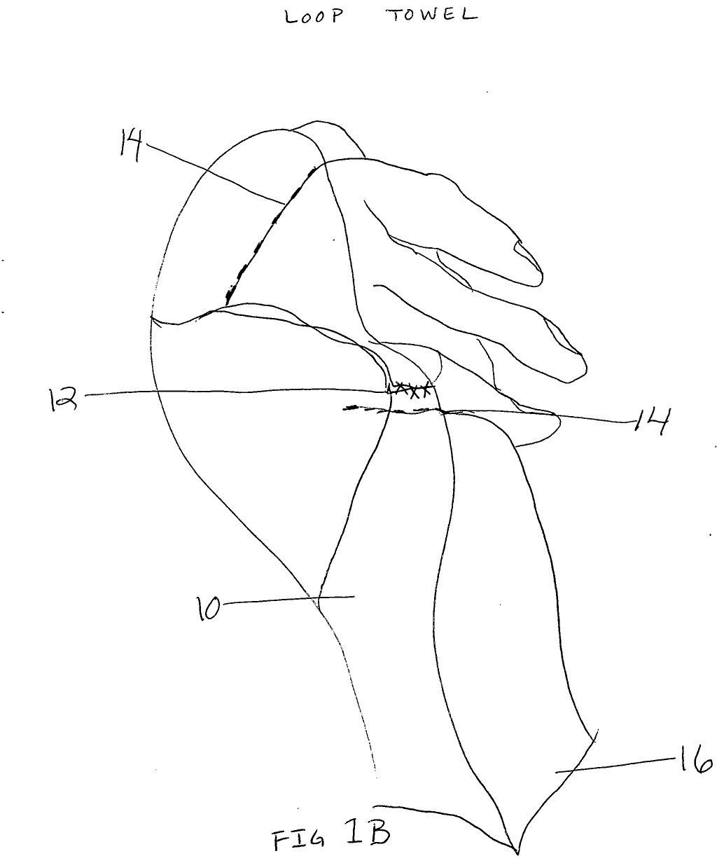

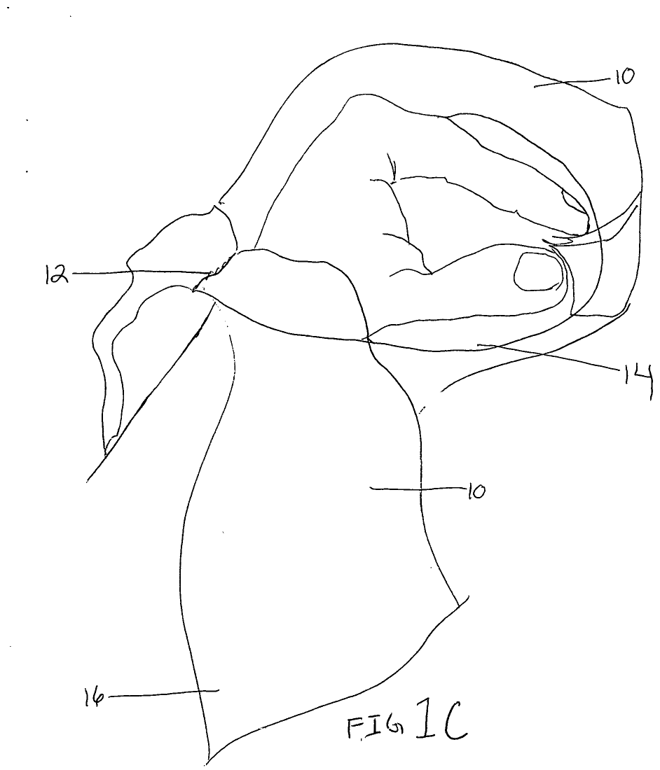

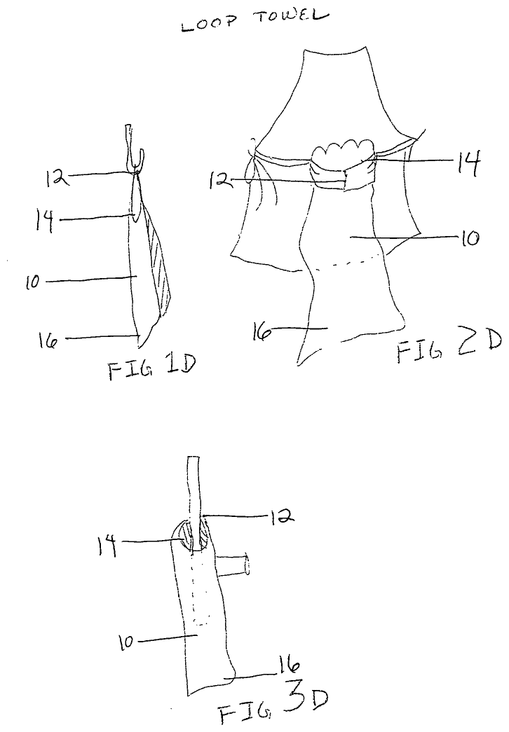

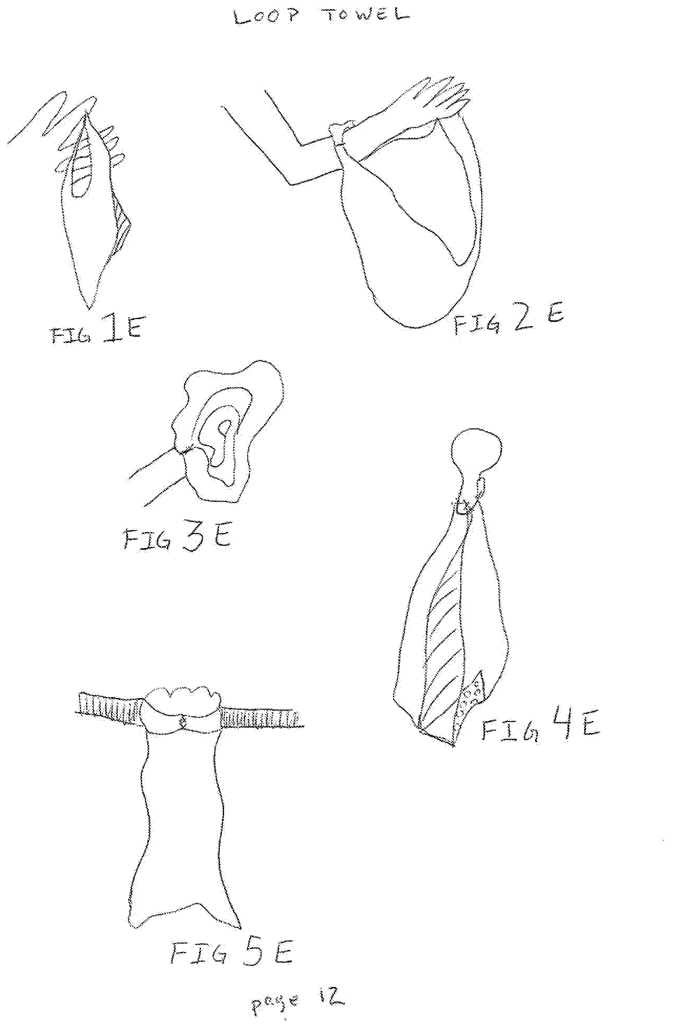

FIG. 1B shows the user's hand inserted through the loop and the material of the towel wrapped around the user's hand.

FIG. 1C shows the loop of the towel over the user's wrist and a loose corner grasped by the user's fingers shortening and manipulating the towel.

FIG. 1D shows the loop of the towel hanging on a hook.

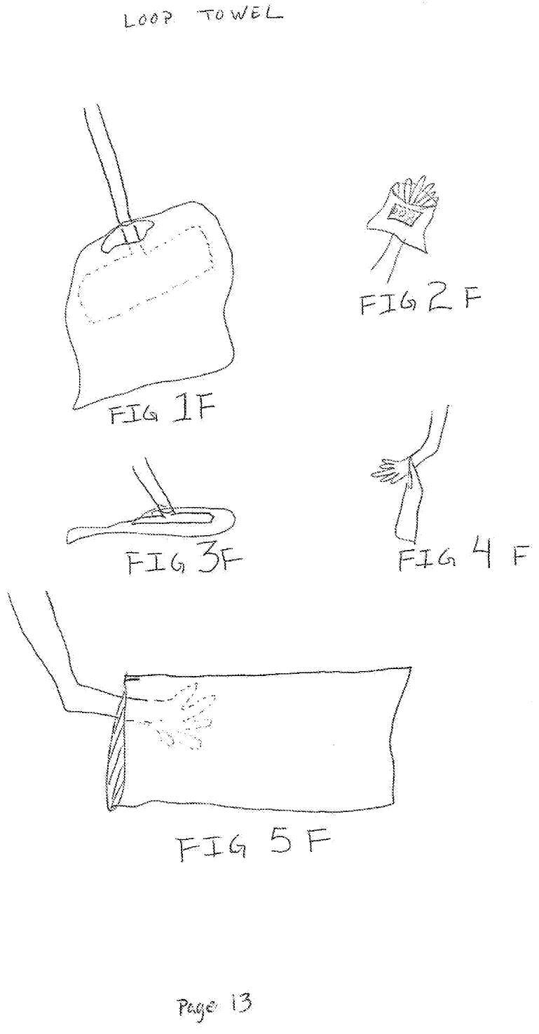

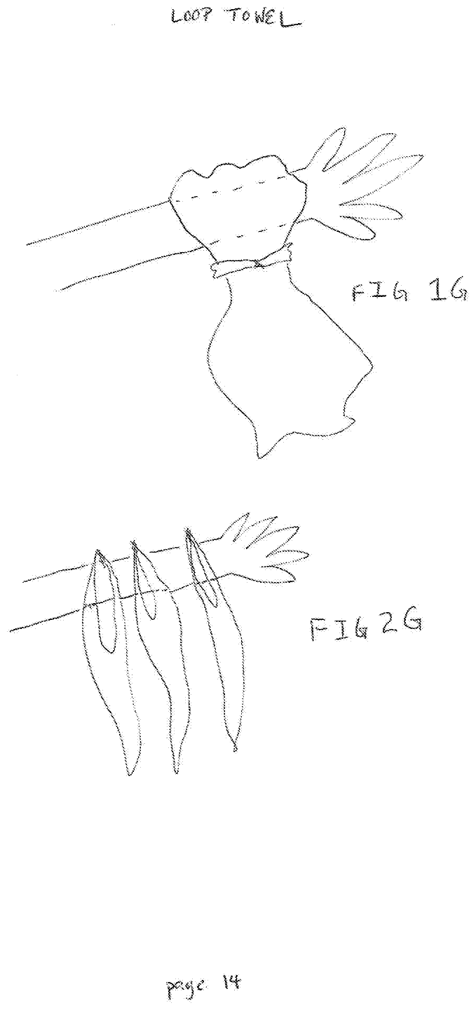

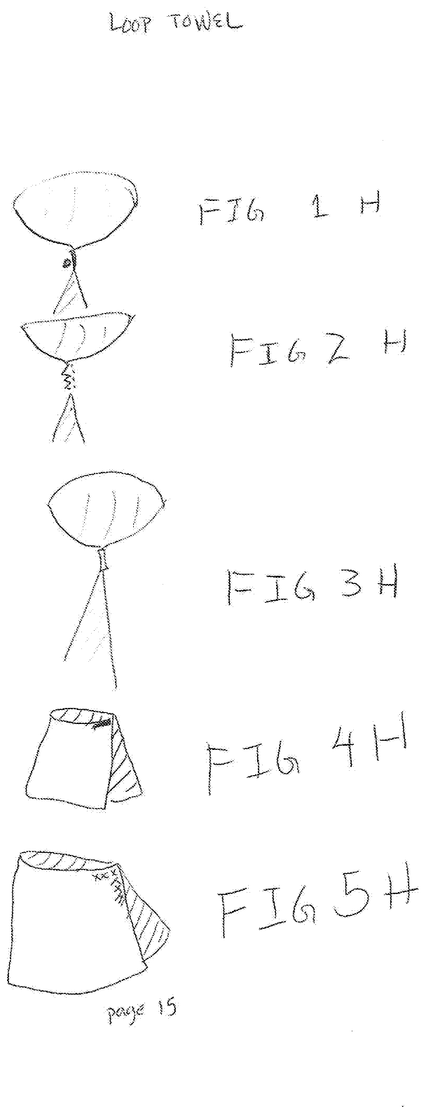

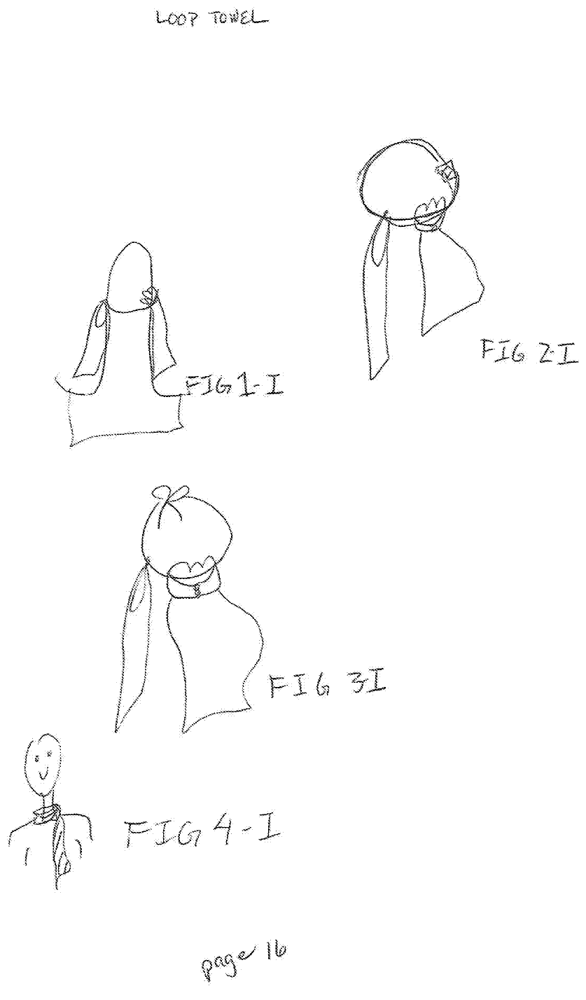

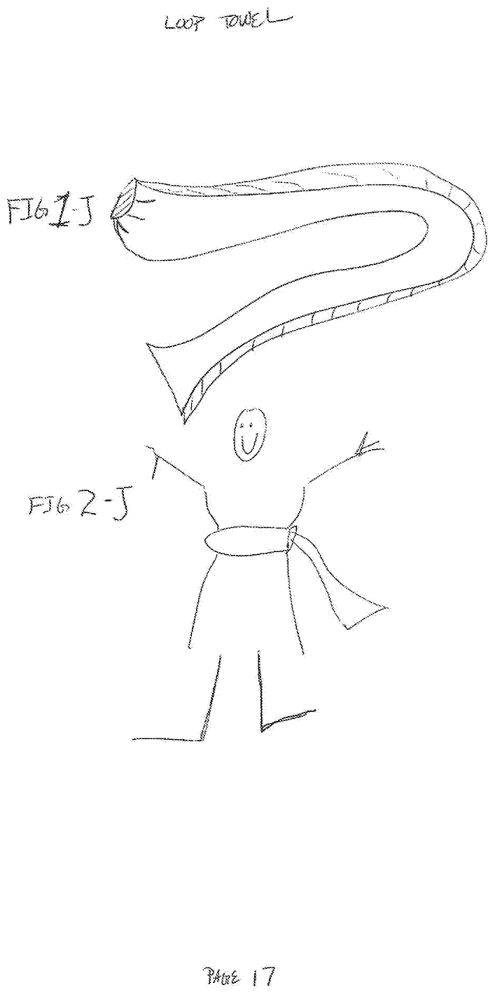

FIG. 2D shows the loop of the towel looped over and apron string.

FIG. 3D shows the loop of the towel looped over a squeegee end.

FIG. 1E shows the loop of the towel hanging from a user's finger.

FIG. 2E shows the loop of the towel over a user's forearm and the user has grasped an end of the towel.

FIG. 3E shows the loop of the towel on a user's wrist,and the material of the towel wrapped around the user's hand.

FIG. 4E shows the loop of the towel heeded hooked onto a closable hook.

FIG. 5E shows the towel looped through the loop and hanging on a towel handle.

FIG. 1F shows the loop of the towel around a mop handle.

FIG. 2F shows the hand of a user inserted into the loop of the towel and user's fingers spread out.

FIG. 3F shows a mop head pushing the material of a towel with the loop of the towel attaching the mop to the towel.

FIG. 4F shows the loop of the towel hanging on a user's wrist.

FIG. 5F shows a user's hand through the loop of a large towel.

FIG. 1G shows a loop towel looped through itself onto a user's arm, the looped material may also be of a ribbonry scarf type material for decoration.

FIG. 2G shows several loop towels where a user has inserted their hand wrist and arm through the loop openings and is carry several towels.

FIG. 1H shows a snap fastener applied to create the loop.

FIG. 2H shows a zig zag stitch or a straight stitch to create the loop.

FIG. 3H shows a hook and loop fastener to create the loop.

FIG. 4H shows a fastening on the upper loop area of the towel.

FIG. 5H shows fastening on the upper loop area as well as along the side of the material.

FIG. 1-I shows a bib apron with a loop towel on each side an open loop and a looped loop.

FIG. 2-I shows a belt with a loop towel, an open loop and a looped loop.

FIG. 3-I shows a ribbon with a loop towel,an open loop and a looped loop.

FIG. 4- I shows a looped material formed into a scarf for a user to insert their head into the larger loop formed form looping the towel and placing the loop around the user's neck.

FIG. 1J shows a darted opening at the loop applied to a long and narrow material.

FIG. 2J shows the looped material placed around a user's waist forming a belt.

I claim:

1. In a device of material formed to comprise a material with a single shallow length integral loop formed there on, fastened and sewn closed of the material of itself, for attaching to a user's person for ease of use to attach and transport of a looped device

2. The device of claim 1 wherein said loop may be attached to another item via the shallow fastened and sewn closed loop formed, and the material wrapped around the item, and thru the loop.

3. The loop formed of claim 1 where said loop is identifiable by means of an identifiable fastened closed end and an open end of the same material.

4. The loop formed of claim 1 formed to receive an item, or tool, or a user's human part placed within the shallow closed loop.

5. The loop towel of claim 1 having additional fastening means as hook and loop, snaps, variable sewing stitches.
